(19) United States
(12) Patent Application Publication
(10) Pub. No.: US 2004/0074265 A1
(43) Pub. Date: Apr. 22, 2004

(54) Securing device

(76) Inventors: Jochen Bruening, Gerscher-Hochmoor (DE); Stephan Schwanekamp, Gerscher-Hochmoor (DE); Winfried Stienen, Gerscher-Hochmoor (DE)

Correspondence Address: Karl F Milde Jr, Milde & Hoffber, Suite 460, 10 Bank Street, White Plains, NY, 10606, US

(21) Appl. No.: 10/468,577

(22) PCT Filed: Feb. 21, 2002
(86) PCT No.: PCT/EP02/01817

(30) Foreign Application Priority Data
Feb. 26, 2001 (DE) 10109573.2

(51) Int. Cl. E05B 69/00; E05B 65/00

(52) U.S. Cl. 70/59; 70/57.1

(57) ABSTRACT

The invention relates to a wardrobe securing device comprising a securing bow-shaped element (30) with two connected ends, whereby one bow end (32) is interlocked by a closing cylinder (20) in an end-receiving element (14) with an interlocking device (24). Said device also comprises a securing cable (40) whereby one of the ends thereof can be wound onto or wound off a rotatable drum (44) and is provided with a catch head (42) which can be engaged inside the cable interlocking device (22). Said one bow end (32) is provided with a plurality of notches (34) wherein a catch bolt (25) can be actuated with the aid of the closing cylinder (20).

The invention relates to a wardrobe-securing device with a housing, a securing bow with two connected bow ends that each may be inserted into a bow-end receptacle in the housing whereby at least one bow end may be secured in a bow-end receptacle using a bow-securing device by means of a locking cylinder, and a securing cord whose one end is attached to a drum that is free to rotate within the housing and on which it may be wound and unwound, and whose other end includes a ratcheting head that may be engaged in a cord-locking device.

Such a device is known from DE-PS 880 769 that includes a drum within its housing with a wire wound on it. At its loose end, the wire includes a ring that may be hung on the padlock integrated into the top of the housing. The user is thus presented with a wire of adequate length to secure travel luggage or pieces of clothing that is otherwise unsecured. It is particularly impossible using the known cord lock to secure a garment or luggage to any available wardrobe hanger.

A wardrobe-securing device is further known from DE-PS 43 612 in which the securing bow may be displaced with respect to the housing to the extent that a wardrobe hanger may be firmly clamped between the securing bow and the housing. The housing includes a flap on the front. By opening the flap, a clothing hanger on which a garment may be hung is released within the housing. The front plate of the device is then closed so that the garment with its hanging loop hangs down from the housing that is open to the bottom, and access to the clothing hanger within the housing is prevented. The disadvantage here is that the garment may only be secured by the stitched hanging loop. The stitching here offers only limited resistance. The known device also allows a chain to be hung on the clothing hanger behind the closeable front plate. Operation of a chain of adequate length to be extended through an arm of the clothing to be secured, however, is very inconvenient. The chain must be completely removed from this conventional wardrobe-securing device and collected by hand so that it will fit into the storage space available behind the front plate of the device. The length and thickness of the chain are limited by this storage space.

Also pertinent is U.S. Pat. No. 4,885,920 A that describes a wardrobe-securing device of the type mentioned at the outset, but the device has the disadvantage that a secure attachment is possible only to a wardrobe rod that is secured at both ends. If such a wardrobe rod is not present, or if only secured clothing hangers are present, the former locking device cannot be used.

It is therefore an objective of this invention to develope such a wardrobe-securing device further so that convenient, fairly secure attachment of garment within wardrobes and to wardrobe rods secured only at one end is ensured, and that particularly allows a garment to be secured through its arm.

This objective is achieved by a wardrobe-securing device of the type mentioned at the outset in which at least one bow end includes several notches which can be engaged inside the cable interlocking device by means of a catch bolt that may be actuated by the closing cylinder.

The advantages achieved by the invention particularly consist of the fact that the securing bow incorporated with the lockable notch mechanism within the housing allows securing of the entire device to available clothing hangers. The line cord integrated into the housing allows the securing cord to be passed through suitable openings in a garment, particularly through an arm, and subsequently secured within the device housing with a lock. A suitcase or similar article may also be secured by passing the cord through the handle.

Both the bow-locking device and the cord-securing device may be actuated by means of a closing cylinder, preferably a common one. The user must thus maintain only one key, and may release both the cord and the engagement of the bow notches simultaneously. Thus, the cord may be removed from the garment and the entire wardrobe-securing device may be removed from the wardrobe hanger. The cord is automatically wound into the drum integrated within the housing by a spring mechanism or similar device.

It is particularly advantageous if a coin-operated device is provided that, upon deposit of a coin, releases the actuation of the closing cylinder and/or that allows the withdrawal of a key inserted into the closing cylinder. Thus, the wardrobe-securing device based on the invention may be made available to customers at a price.

Additional advantageous embodiments may be taken from the dependent claims, and from the following descriptions of embodiment examples.

In the following, the invention will be described in greater detail using illustrations, which show:

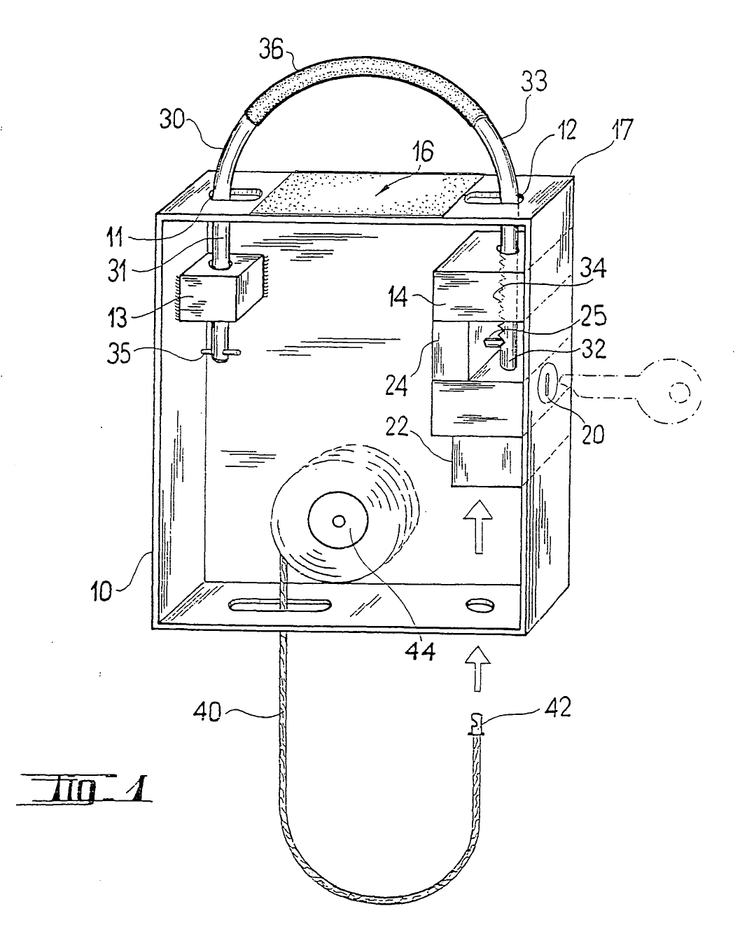

FIG. 1 a partially-opened wardrobe-securing device in perspective view;

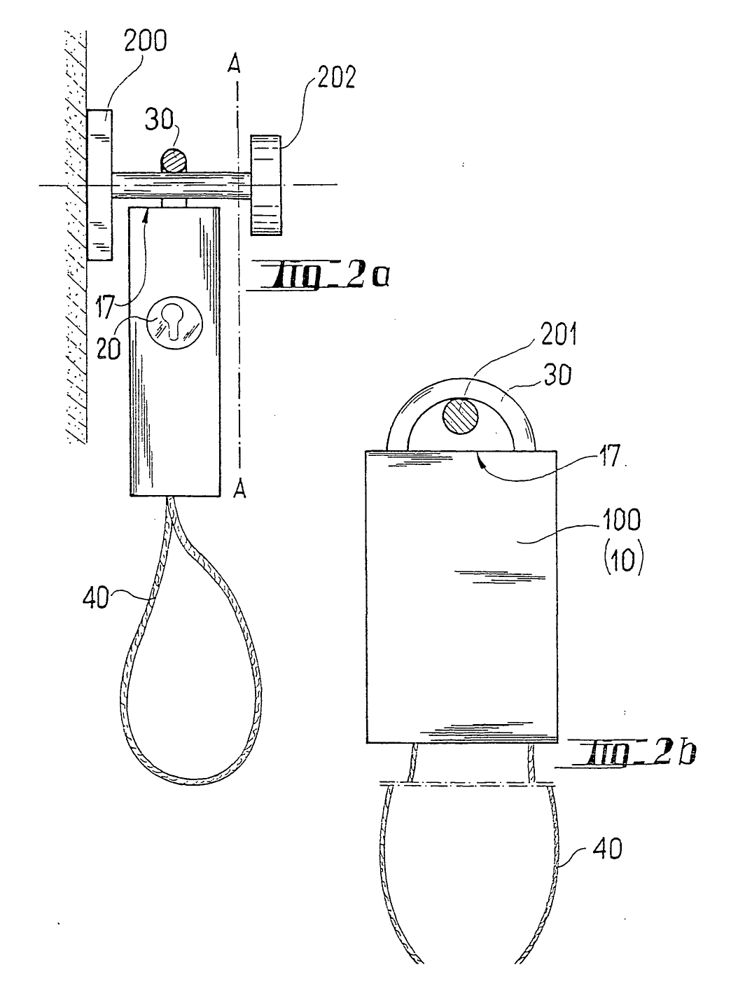

FIG. 2a, 2b securing of a first embodiment of the wardrobe-securing device to a wardrobe hanger, both in lateral and frontal view, and

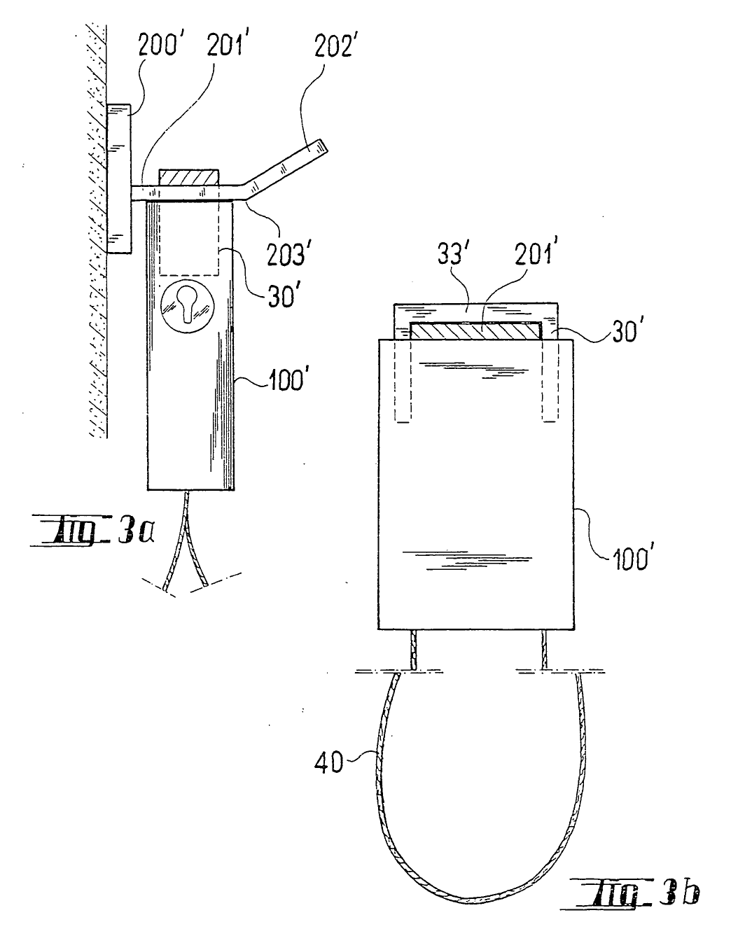

FIG. 3a, 3b securing of a second embodiment of the wardrobe-securing device to a wardrobe hanger, both in lateral and frontal view.

FIG. 1 shows the wardrobe-securing device according to the invention in which a front plate of the housing 10 is removed. There are two recesses 11, 12 in the upper side of the housing 10 for a securing bow 30. The securing bow 30 is basically bent into a U-shape, and includes two parallel bow ends 31, 32 that are connected together via a bow section 33. The ends of the bow 30 may be inserted through the recesses 11, 12 into the housing 10, and then rest in the bow-end recesses 13, 14.

One bow end 32 includes several notches 34. Further, a bow-locking device 24 is positioned with a catch bolt 25 that engages in the notches and secures the bow 30 against extraction from the housing 10 until the bow-locking device 24 is again released by actuation of a locking cylinder 20.

Further, a cord drum 44, onto which a locking cord 40 is wound, is mounted within the housing 10 so that it may rotate. The loose end of the locking cord 40 located outside the housing includes a catch head 42 that may engage within a cord-securing device 22 that is affixed within the housing 10. By actuation of the locking cylinder 20, the cord-securing device 22 and the bow-locking device 24 are simultaneously released. The cord 24 may be pulled farther out of the housing 10 by its catch head 42, and rewinds onto the drum 44 via a spring mechanism integrated within it.

The bow 30 may be raised with respect to the upper side 17 of the housing 10 to the extent that a wardrobe hanger secured between the bow 30 and the housing 10 is again released. Thus, the bow 30 may particularly be withdrawn from the housing to the extent that the bow-end 32 is free, so that the bow 30 may pivot about the bow-end recess 13. The bow end 31 has its end secured against withdrawal from the bow-end recess 13 by a cross-bolt 35, which prevents the bow 30 from being withdrawn from the housing 10.

The first embodiment of the invention described above includes a bow with a U-shaped, rounded bow section 33. As FIG. 2a shows, the bow 30 and the housing upper side surround a wardrobe hanger 200. Removal of the wardrobe-securing device 100 from the wardrobe hanger 200 is not possible once the bow 30 is secured within the bow-locking device 24.

In an additional embodiment shown in FIGS. 3a and 3b, a wardrobe-securing device 100′ includes a securing bow 30′ with a rectangular shape. In this one, the bow ends are connected together via a matching rectangular mid-section 33′. This embodiment is advantageous for those wardrobe hangers 206′ whose cross-section is also rectangular, and that does not possess a thickening in cross section but rather an angled hanger area 202′. The rectangular embodiment of the wardrobe-securing device 100′ makes it possible to secure the wardrobe hanger 200′ between bow 30′ and housing 10′ so that it is impossible to slide the wardrobe-securing device 100′ past a bent point 203′ on the wardrobe hanger 200′.

A friction-increasing inset 16 (see FIG. 1) is mounted on the upper side 7 of the housing 10. Also, the securing bow 30 is at least partially provided with a friction-increasing coating 36. Thus, scratching of the wardrobe hanger 200, 200′ is avoided during securing the wardrobe-securing device 100, 100′. Noise reduction is achieved, and the clamping effect is increased.

1. Wardrobe-securing device with a housing (10, 10′), a securing bow (30; 30′) with two connected bow-ends (31, 32) each of which may be inserted into a bow-end recess (13, 14), whereby at least one bow-end (32) may be secured within a bow-end recess (14) by means of a bow-locking device (24) via a locking cylinder (20), and with a securing cord (40) that has one end secured to a drum (44) that may rotate within the housing and thus may be wound onto, and unwound from, it, and that includes a catch head (42) on its other end that may engage into a cord-securing device (22), characterized in that at least one bow end (32) includes several notches (34) into which the catch head may engage via a catch bolt (25) which may be actuated by means of a locking cylinder (20).

2. Wardrobe-securing device as in claim 1, characterized in that the cord-securing device (22) may be actuated by the locking cylinder (20) so that the bow-locking device (24) and catch head (42) of the securing cord may be simultaneously released.

3. Wardrobe-securing device as in claim 1 or 2, characterized in that the upper side (17) of the housing (10) and/or the outer side of the securing bow (30) is at least partially provided with a friction-increasing coating (16, 36).

4. Wardrobe-securing device as in one of claims 1 through 3, characterized in that the bow (30) includes a circular, rounded mid-section (33).

5. Wardrobe-securing device as in one of claims 1 through 3, characterized in that the bow (30) possesses a rectangular shape.

6. Wardrobe-securing device as in one of claims 1 through 3, characterized in that a coin-operation device is provided that, upon insertion of a coin, releases the actuation of the locking cylinder and/or allows the removal of a key inserted into the locking cylinder.
